(19) United States
(12) Patent Application Publication
(10) Pub. No.: US 2003/0040921 A1
(43) Pub. Date: Feb. 27, 2003

(54) Method and system of online data collection

(76) Inventors: Larry James Hughes, Cincinnati, OH (US); Roxanne Drago Westendorf, Cincinnati, OH (US); Jacqueline Westfield, Walton, KY (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 09/935,245

(22) Filed: Aug. 22, 2001

(51) Int. Cl. G06F 17/60; G06F 15/16

(52) U.S. Cl. 705/1; 709/205

(57) ABSTRACT

An online data collection system having an image bank module with a plurality of images. The image bank module is in selective communication with a panelist interface that receives and displays the plurality of images. A panelist interface facilitates panelist input of a selection of at least one image from the display of the plurality of images. The system also has a research interface arranged in communication with the image bank module. The research interface allows selective access to the panelist input, and a communication device is provided at the research interface and facilitates analysis of the panelist input. The online data collection system also allows selective manipulation of one or more of the images in the image bank module and allows additional images to be added to the image bank module. The system is also provided with executable instructions which can include application sharing software to facilitate image sharing and the communication device of the present invention is a web cam for receiving and displaying video.

The present invention relates to an online data collection system, and, more particularly, to a system and method of providing an online data collection system designed to allow a researcher to develop a deeper understanding of the factors underlying consumer preferences and purchase decisions, product adoption, habit formation, brand meaning, and consumer needs.

### BACKGROUND OF THE INVENTION

Consumer product manufacturing companies make decisions everyday regarding ways to improve existing products and/or to create better products. In creating a better product solution, these companies strive to understand the factors that underlie consumers' relationships with their brands, purchase decisions, habits formation, preference trends, and needs. One of the ways for companies to gain an understanding of these factors is to collect data, such as through a consumer interview to learn why a consumer purchased a particular product, to find improvements that could be made on a particular product, to understand how consumers have incorporated a product into their lives and how they feel about brands. For example, a traditional data collection approach might be for a consumer product manufacturing company to ask consumers testing or purchasing a particular product a plurality of questions relating to the product or might provide a consumer with an applicable questionnaire.

Sometimes, however, the traditional data collection approach is ineffective because consumers may not be able to articulate a reason for purchasing a particular product, how they use a product, how they form opinions about a product or consumers may not recognize that there could be ways to improve a product. As such, it is important for consumer product manufacturing companies to research outside the boundaries of the traditional interviewing approach. For example, it has long been recognized that images provoke sensory stimulus and communicate information unattainable through a traditional interview. As a consequence, a consumer product manufacturing company that can utilize both verbal and nonverbal research methods might be put in a position to design, manufacture, and market products better.

Moreover, there are a number of problems associated with the traditional interview approach. For example, most consumers do not want to be inconvenienced by having to participate in an interview or, by having to travel to an interview located at a centrally located facility. Where data collection, such as an interview, is to be conducted in a consumer's home, it is costly and time consuming from a research standpoint to conduct multiple interviews. Additionally, consumers may feel compelled to entertain a researcher conducting an interview or to clean up the home prior to a researcher's arrival. Moreover, a consumer may feel inhibited due to the presence of a stranger in the home, which may cause the researcher to collect non-representative data. These circumstances may prevent a researcher from actually learning and understanding the reasoning behind a consumer's purchase decision, or a consumer's related actions, feelings, and needs. In view of these limitations, it would be advantageous to provide a system and method of collecting consumer data without incurring the limitations associated with the traditional data collection approach while retaining the benefits of a personal interview.

An online data collection system is one such solution which might allow a researcher to collect data or interview a consumer via a video connection. This direct communication connection may alleviate some of the awkwardness associated with the traditional in-home interview approach and may allow the researcher to obtain more accurate and in depth data.

In addition, providing a video connection such as a web cam, might allow a researcher to more candidly see the facial and/or body expression's of a consumer, which may provide further insight into a consumer's state of mind. Also, providing such a system may allow a researcher to view a consumer performing a particular task relating to an interview topic or allow a researcher to view events that might not otherwise be possible, such as, for example, viewing a consumer interacting with a pet. Moreover, an online data collection system might allow a researcher access to typically difficult interviewing populations, such as the elderly who have a difficult time traveling, or the homebound population due to illness or other factors.

### SUMMARY OF THE INVENTION

In one embodiment of the invention, an online data collection system comprises an image bank module having a plurality of images. The image bank module is in communication with a panelist interface that is configured to receive and display the plurality of images and to facilitate panelist input comprising a selection of at least one image from the display of the plurality of images. The system also comprises a research interface arranged in communication with the image bank module. The research interface is configured to allow access to the panelist input. A communication device is provided at the research interface and is configured to facilitate analysis of the panelist input.

Another embodiment of the invention might be a method of collecting data, comprising the steps of providing an image bank module having a plurality of images in communication with a panelist interface. A panelist interface is configured to receive and display the plurality of images and to facilitate panelist input including a selection of at least one image from the display of the plurality of images. Such panelist input is received and a research interface is provided that is arranged in communication the image bank module. The research interface is configured to provide access to the panelist input, and a communication device is also provided at the research interface, and configured to facilitate analysis of the panelist input.

Still other objects, advantages and novel features of the present invention will become apparent to those skilled in the art from the following detailed description, which is simply, by way of illustration, various modes contemplated for carrying out the invention. As will be realized, the invention is capable of other different aspects all without departing from the invention. Accordingly, the drawings and descriptions are illustrative in nature and not restrictive.

### BRIEF DESCRIPTION OF THE DRAWINGS

While the specification concludes with claims particularly pointing out and distinctly claiming the present invention, it is believed the same will be better understood from the following description taken in conjunction with the accompanying drawings in which:

FIG. 1. depicts schematically an exemplary embodiment of an online data collection system according to the present invention;

FIG. 2. is a schematic illustration of an online data collection system in accordance with the present invention;

FIG. 3. is a schematic illustration of another exemplary embodiment of an online data collection system according to the present invention;

FIG. 4. is another exemplary schematic illustration of an online data collection system in accordance with the present invention;

FIG. 5. depicts a flowchart of a method of collecting data according to the present invention;

FIG. 6. depicts an illustration of an exemplary page view of a Selection Page as might be displayed in an embodiment of the present invention; and

FIG. 7. depicts an illustration of an exemplary page view of an Edit Selection Group page as might be displayed in accordance with an embodiment of the present invention.

### DETAILED DESCRIPTION OF EXEMPLARY EMBODIMENTS

Reference will now be made in detail to various embodiments of the invention, various examples of which are illustrated in the accompanying drawings, wherein like numerals indicate corresponding elements throughout the views.

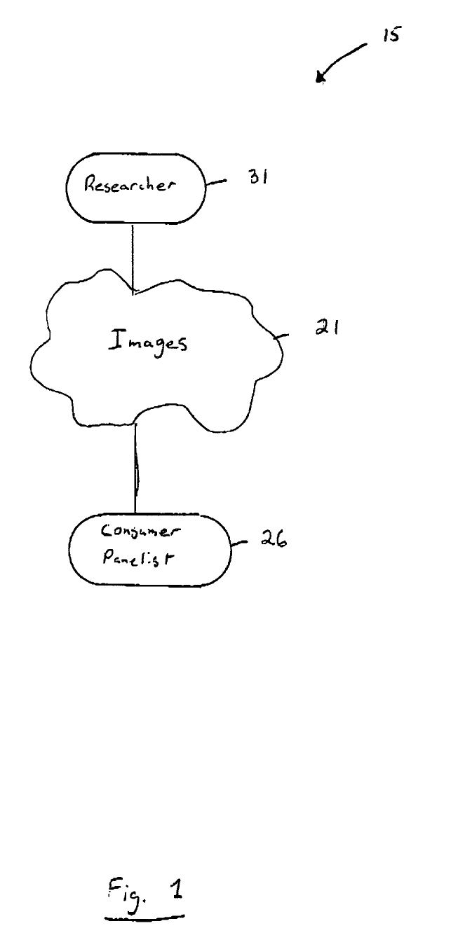

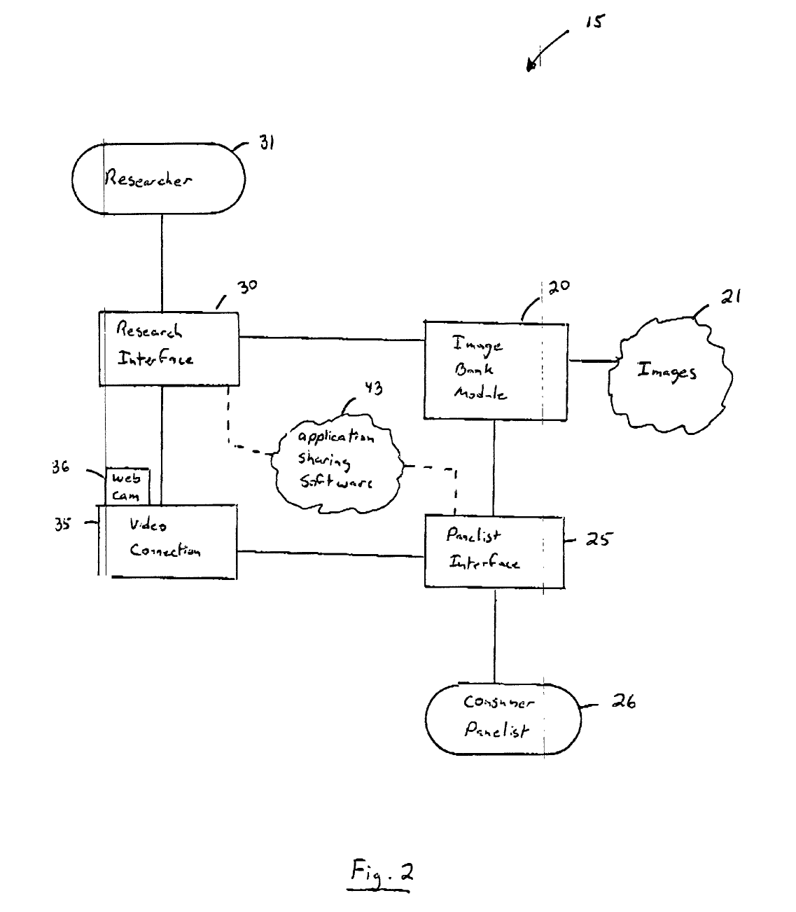

A non-limiting embodiment of the present invention is schematically illustrated in FIG. 1, which depicts an online data collection system 15, generally designed to facilitate consumer product research and development. System 15 allows a researcher 31 in communication with a system 15 to collect data, such as through an interview with a consumer, to better understand the factors that underlie consumer purchase decisions. In particular, consumers are asked to interact with a plurality of images 21 that are designed to represent the psychological or emotional aspects of a topic being studied. The images 21 selected by the consumer represent how the consumer thinks or feels about a topic, which is then interpreted and analyzed by a researcher 31, and used to design or improve a product that potentially better fulfills the consumer's needs.

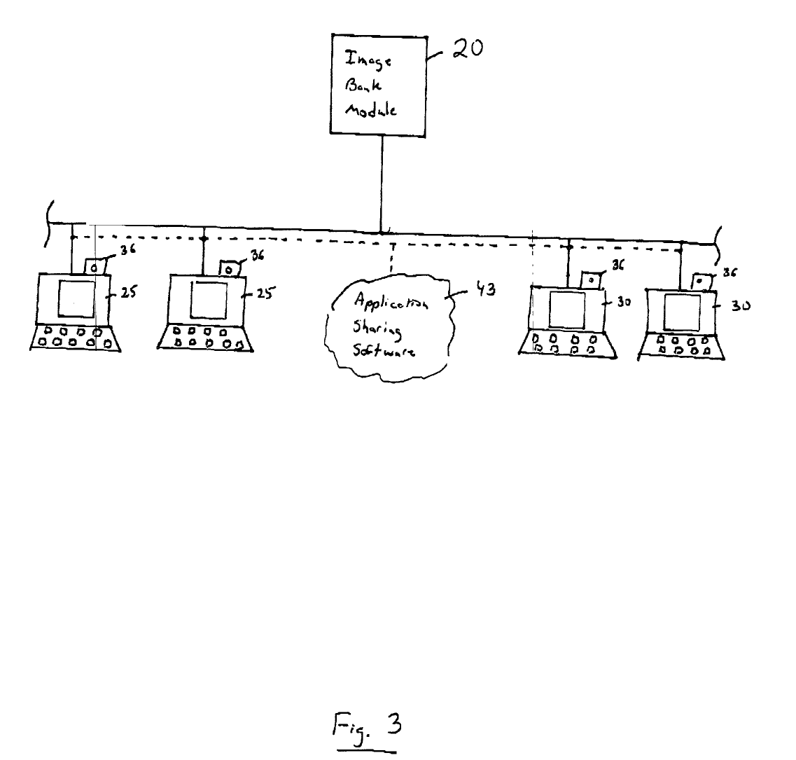

FIG. 2 schematically illustrates a more detailed online data collection system 15. In general, and as will be more fully discussed below, a system 15 might comprise an image bank module 20 having a plurality of images 21 that are configured to be electronically transmitted to a panelist interface 25 accessible by at least one consumer panelist 26. A consumer panelist 26 in communication with a panelist interface 25 is capable of viewing, adding, manipulating, and/or modifying the images 21, and selecting and submitting any image that captures the consumer's thoughts and feelings relating to a particular pre-assigned interview topic. A research interface 30 and a consumer panelist interface 25 comprise executable instructions such as application sharing software 43 to allow the consumer panelist 26 to share images 21 with researcher 31 and vice versa. Moreover, the researcher 31 is also provided with communication to a consumer panelist 26 through a video connection 35, such as a web cam 36, to allow the researcher to collect data relating to a consumer's selection of images as related to the pre-assigned interview topic. A researcher 31 might utilize a number of interviewing techniques, such as, but not limited to, Storytelling, Deeper Insights, Kelly Repertoire Grid or Concept Sharing to understand the psychology underlying a consumer's selected images and how those images relate to a particular interview topic. Upon analyzing a consumer's selected images, a researcher 31 might then be provided with a deeper understanding of a consumer's needs and may also be provided with insights relating to improving, developing or advertising a particular product, or the like.

It should be recognized from the foregoing that a researcher's analysis of a consumer's selected images might occur online, offline, or any combination thereof. Also, it should be recognized that the data collected by a researcher includes, but is not limited to interview questions and answers, audio observations such as music, voices, tones and inflections, visual observations, body language, emotions, image submissions, selections, additions, modifications and manipulations.

As mentioned, a purpose of such an online data collection system 15 might be to learn more about factors that underlie consumer purchase decisions as related to purchasing products and services. Another purpose might be to provide a deeper understanding of the needs and motivations of consumers as related to products and advertising available on the market and how those products and advertisements might be improved. For example, a system 15 might be used by a researcher 31 to understand consumer habits relating to sorting laundry. A consumer may select a number of images 21 relating to the consumer's feelings about sorting laundry such as an image showing an erupting volcano. Such a selection by a consumer may show anger or a hatred toward sorting laundry. Upon interviewing the consumer panelist 26 via a video connection 35, such as with a web cam 36, a researcher may confirm that consumers with such feelings typically do not sort laundry. Armed with such knowledge, a researcher 31 might be able to help a consumer products manufacturing company formulate an improved laundry detergent for the population of consumers that do not sort laundry. While the above example is illustrative of an application of the present invention, it should be recognized that the example is only one of numerous applications that could be carried out by the invention, and that applications of the invention are not limited to product improvements.

In general, it should be recognized that a system 15, as depicted in FIG. 2, could comprise a single integral set of executable instructions, such as in the form of software, routines, programs, algorithms and/or code, or that portions of these executable instructions could be handled by several components of a system working in combination. For simplicity of discussion, a system 15 is illustrated by separate components such as, but not limited to, an image bank module 20, a panelist interface 25 and a research interface 30, wherein each component comprises an appropriate set of executable instructions or the like. It is contemplated that the components of a system 15 could be provided on a single system or multiple systems in various parts of the world to allow efficient access to the system 15 at any time and from anywhere in the world. Moreover, each component of a system 15 might be provided in communication with each of the other components, such as via a token ring, Ethernet, telephone modem connection, radio or microwave connection, parallel cables, serial cables, telephone lines, universal serial bus “USB”, Firewire, Bluetooth, fiber optics, infrared “IR”, radio frequency “RF”, or combinations thereof.

It is further contemplated that in an exemplary embodiment of the present invention an online data collection system 15 might be operated through a web-site hosted on a network such as a wide-area network, local-area network, or the Internet. Such an embodiment might provide numerous advantages for consumers 26 over traditional data collection or interviewing approaches, such as, for example, a consumer might no longer have to physically participate at a research facility at a specific time. Accordingly, a researcher 31 may be able to collect data such as through an interview of a consumer 26 while the consumer is in the comfort of their own home, providing a more natural setting and allowing the researcher to collect better data. Additionally, interviewing a consumer panelist 26 in the home may allow a researcher 31 to view a consumer panelist performing a particular task relating to a pre-assigned interview topic that might not otherwise be possible, such as, for example, how a home owner interacts with a pet or other ambient interactions. Moreover, an online data collection system 15 might allow a researcher 31 access to typically difficult interviewing populations, such as the elderly who have a difficult time traveling, or the homebound population due to illness or other factors. An online data collection system might also allow a researcher to conduct interviews with consumers in different cities or countries without the need to physically travel.

In a non-limiting embodiment of the invention, such as contemplated in FIG. 2, a system 15 is accessible by at least one consumer panelist 26 through a panelist interface 25. Consumer panelists 26 might typically be volunteers who agree to participate in data collection in exchange for some type of reward, such as free merchandise, coupons, or other benefits. In an exemplary embodiment of the invention, it is contemplated that a possible reward might be a free web cam or other equipment or software that may be provided as part of the data collection system, such as Microsoft NetMeeting®. In other words, in an exemplary embodiment of the present invention, a consumer panelist 26 might be provided with a home web cam, such as a 3 Com HomeConnect PC digital camera and appropriate application sharing software 43, such as Microsoft NetMeeting® which would allow a consumer panelist 26 to participate in data collection, such as an interview, from home. In exchange for a consumer panelist's participation in a data collection program, for example, a consumer panelist 26 is allowed to keep the web cam or an application sharing software package.

A researcher (e.g., 31) as described throughout the invention is contemplated as a person or group of persons seeking to learn more about the factors that underlie consumer behaviors and decisions, attitudes and needs relating to their research topics. In one embodiment of the invention, researcher may work for or provide consulting to a consumer product manufacturing company. It is contemplated that one or more researcher(s) 31 might be in communication with system 15 through research interface 30.

In a non-limiting embodiment of the present invention, an online data collection system 15, might comprise a panelist interface 25 and a research interface 30 to facilitate communication with a system 15. Panelist interface 25 and research interface 30 might be configured to receive and display a single image or a plurality of images transmitted from image bank module 20, to receive consumer panelist 26 and researcher 31 input, respectively, and to transmit such input to the image bank module 20. Although a panelist interface 25 and a research interface 30 might be in communication with any component of a system 15, in an exemplary embodiment, both a panelist interface 25 and research interface 30 might be in communication with image bank module 20 to allow a consumer panelist 26 and a researcher 31, respectively, to communicate with the image bank module 20. It should be recognized that a research interface 30 might be configured to provide access to a panelist's input. In other words, a research interface 30 should allow researcher 31 to access consumer panelist's 26 input, such as images selected and submitted by the panelist.

In a non-limiting embodiment of the invention, a panelist interface 25 and/or a research interface 30 might comprise a kiosk, computer, personal digital assistant (PDA), a device with wireless application programs (WAP) such as cell phone, auto computer, interactive TV, an Internet appliance, or other access device. In one relatively common exemplary embodiment, a panelist interface 25 and/or a researcher interface 30 may comprise a computer system having a CPU, memory, a visual display device and a keyboard or other input device such as a mouse or joystick Additionally, in one embodiment of the invention, such interfaces (25 and/or 30) might be configured with a video connection 35, such as a 3 Com HomeConnect PC digital camera and application sharing software 43 such as Microsoft NetMeeting®, and may comprise an Internet connection through a communication link and running a web browser such as Internet Explorer from Microsoft Corp. or Netscape Navigator from Netscape Communications Corp.

A system 15 might further comprise an image bank module 20, which among other things, is configured to transmit a single image or a plurality of images to a panelist interface 25 and/or a research interface 30. In an exemplary embodiment of the invention, image bank module 20 is in communication with between about 1000 and about 1500 images, although it should be recognized that an image bank module 20 could comprise as few or as many images as desired. In an exemplary embodiment, an image bank module 20 comprises the plurality of images, however, it should also be recognized that the image bank module might be configured to access images off the Internet, a database, or from any other source such as a digital camera.

The images 21 are contemplated to be pictorial representations of anything real or imaginative such as an idea, cartoon, object, process, and/or event, and could be captured by photograph, drawing, painting, or computer generation or animation. Other examples of images may include, but are not limited to, a cow standing in a field, a palm tree, a sunset, a child eating ice cream, a woman peacefully sitting in a rowboat, a man wearing mismatched clothes, and virtually any pictorial representation one could possibly envision or create. Additionally, it should be recognized that images 21 could be digitally scanned or otherwise created, programmed and stored in a system 15, but in an exemplary embodiment of the invention, the images 21 are stored having an image data format such as JPG, TIF, GIF or other appropriate data format. Further, it is contemplated that a consumer 26 might be capable of printing out, downloading, or ordering any particular image 21 found within the image bank module 20.

In a non-limiting embodiment of the invention, consumer panelist 26 might also be capable of adding images 21 to image bank module 20. Although there are numerous ways for consumer 26 to add images 21 to image bank module 20, in an exemplary embodiment, a one-time use camera available from any photo shop may be sent to the consumer 26. After taking pictures and capturing images 21 representative of an interview topic, the camera may be sent back to researcher 31, who might subsequently have the pictures developed for study and/or adding to the image bank module as images 21. In an alternate embodiment, a consumer 26 might take analog or digital pictures of images representative of the interviewing topic, then have the pictures put on a CD or alternative media, such as available at K-mart, CVS pharmacy, or other photo processing center and subsequently have the media sent to a researcher 31 to add to an image bank module 20. In yet another alternate embodiment, a consumer panelist 26 may also have the capability through a panelist interface 25 to upload any desired image 21 to the image bank module 20. For example, the panelist interface 25 might be provided with a digital camera or scanner capable of scanning an image into a panelist interface 25 and thereafter uploading the image 21 to an image bank module 20. In any of these embodiments, it should be recognized that images 21 added to an image bank module 20 might only be viewable by the consumer 26 that took or uploaded the images 21 due to ownership and/or privacy concerns, or submitted images may require an appropriate release by the consumer. Additionally, it should be recognized that a purpose behind allowing a panelist 26 to add images 21 to the image bank module 20 is to allow the consumer to share his/her own experiences and to represent those experiences as they relate to the interview topic.

An image bank module 20 might be provided with tools that allow a researcher 31 in communication with a research interface 30, consumer panelist 26, or panelist interface 25, to view, manipulate and/or modify images 21 within an image bank module 20. Additionally, an image bank module 20 might be provided with tools that allow a consumer panelist 26 to select and/or submit any displayed image 21. As used herein, the term “manipulate” is contemplated to include that images 21 within image bank module 20 can be cropped, rotated or otherwise changed, including the addition or modification of text, graphics, colors, symbols, characters and lines, or any combination thereof. Further, the term “modify” is contemplated to include that a researcher 31 might have the ability to change the order in which images 21 are displayed at a panelist interface 25, which may have been presented in a random order or in an order predetermined by a researcher 31. The term “modify” is also contemplated to include that a consumer panelist 26 might also have the ability to change the order, content and/or other presentation of images selected by the panelist. Additionally, the term “select” is intended to mean that a consumer panelist has the capability to mark or otherwise designate a particular image as representative of the panelist's thoughts and feelings relating to an interview topic. It should be recognized that the various functions and tools of an image bank module 20 might be provided as separate or integral components of an image bank module 20 or as separate or integral components of a system 15. As used herein, the term “tools” is contemplated to include executable instructions, shortcuts and other manipulation features, such as in the form of software, routines, program and code.

An image bank module 20 is configured to receive input from a panelist interface 25 in communication with a consumer panelist 26, or a research interface 30 in communication with a researcher 31 for facilitating consumer product research and development. As used herein, the term “input” is contemplated to include responses, answers, actions, reactions, emotions, additions, selections, manipulations, modifications or submissions of images 21 from a display of images 21 from an image bank module 20.

It is further contemplated that the system 15 might further comprise a direct communication connection, such as a video connection 35 through a web cam 36, for receiving and displaying video between a research interface and a panelist interface. A video connection 35, such as through a web cam 36 may be provided between a panelist interface 25 and a research interface 30 and configured to allow a consumer panelist 26 and a researcher 31 to view each other and to interact through body language. In an exemplary embodiment, a researcher 31 may provide a web cam 36 to a consumer panelist 26 to be installed on a panelist's interface 25. It is contemplated that a web cam 36 might allow a researcher 31 and a panelist 26 to interact or share video communications (either in real time or recorded). In particular, a researcher might receive panelist input such as additions, modifications, manipulations, selections or submissions and in real-time through the web-cam be capable of interviewing the panelist regarding this input. Moreover, a web-cam allows a panelist 26 to show objects or demonstrate in home and/or office tasks to a researcher 31 (or vice versa), such as how the panelist does laundry, or any other home or office based activity. A web cam 36 may be provided with a wireless connection, or an “extension cord” type extension to allow a panelist 26 to move throughout a panelist's home or other interview site. In other words, a panelist interface might be configured with a mobile camera to a allow a consumer panelist 26 to view tasks around, or even outside the home. It should also be recognized that any type of camera could be situated at home for data collection or interviewing purposes. Examples of other types cameras may include, but are not limited to, motion or time sensitive cameras that are intended to capture information periodically and/or relating to a particular interview topic, or, cameras that allow a consumer panelist 26 to take pictures or video before or during an interview, and which may be configured to allow a consumer panelist to share the pictures and/or video with a researcher 31 (or vice versa).

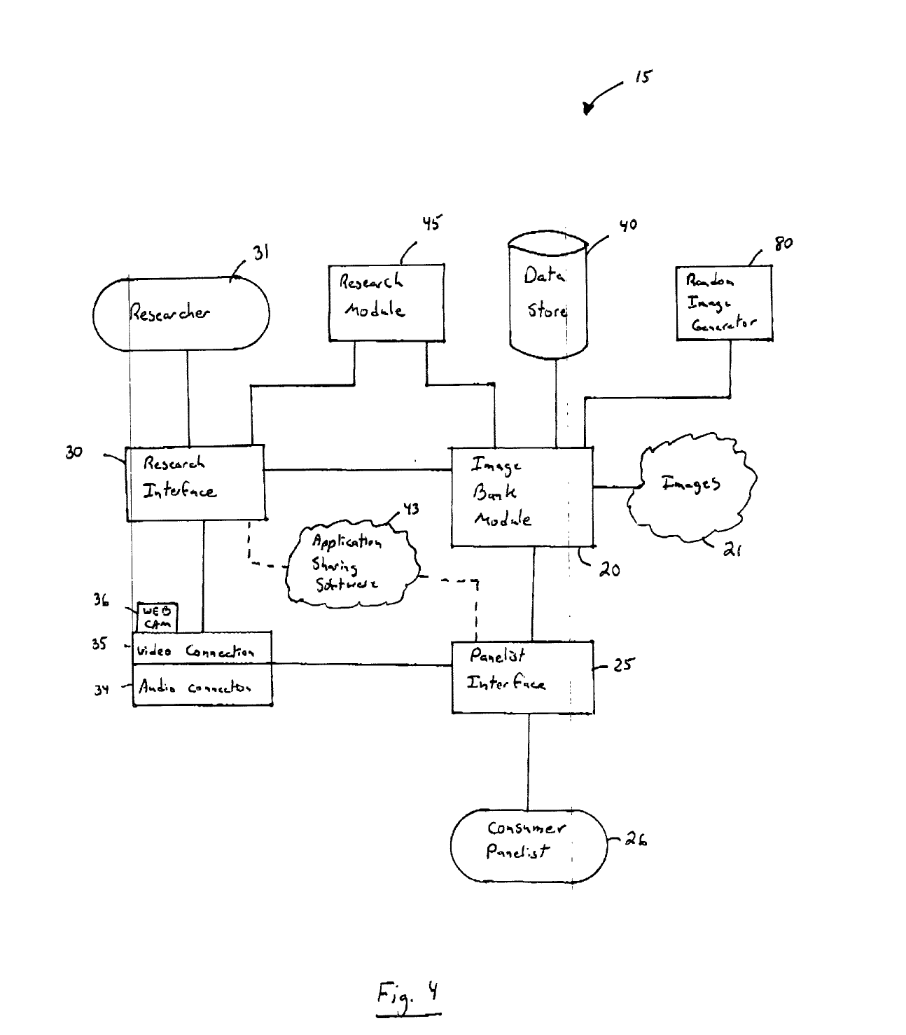

FIG. 3 depicts an exemplary embodiment of the present invention, wherein, it is contemplated that a researcher 31 or group of researchers might be capable of real-time interfacing with one consumer panelist 26 or a plurality of consumer panelists. In more detail, a plurality of panelist interfaces 25 and one or more research interfaces 30 might be each configured with a web cam 36 and application sharing software 43, thereby making it possible for a researcher 31 or group of researchers to real-time interview a consumers panelist 26 or group of consumer panelists. For example, a researcher 31 may desire to set up a multiple-consumer panelist interview. In one embodiment, a researcher may initiate a multi-consumer interview, wherein the panelists being interviewed may be friends or have some type of established relationship. In another embodiment, a researcher may initiate a multi-consumer interview based on a task that each of the panelists has undertaken or based on a particular interview topic. Additionally, it is contemplated that a consumer could initiate a multi-consumer interview by contacting friends, or relatives, or the like. In any event, it should be recognized that a system 15 might be able to accommodate multiple panelist interfaces 25 in communication at the same or different times with a multiple research interfaces 30. That said, panelist interfaces 25 and research interfaces 30 might be located remotely from each other and might be located remotely from any component of a system 15. As used herein the term “remote” is contemplated to mean that a panelist interface and a research interface are separated by a distance such as being located in separate areas of a room, separate rooms, buildings, cities, states, countries, or anywhere connected by communication equipment.

As mentioned, it is contemplated that interfaces (25 and/or 30) in communication with a system 15 might be configured with executable instruction such as application sharing software 43 to allow a user of a system 15 to share applications. In particular, executable instructions such as application sharing software 43, might be provided to allow a panelist interface 25 and a research interface 30 to share images 21 selected by a consumer panelist 26 with a researcher 31 or vice versa. It should be recognized that the executable instruction could be provided at each interface, or, potentially at, or in communication with, an the image bank module for facilitating access to and display of the images. Additionally, application sharing software 43 may also allow other programs, such as other software applications, to be shared between multiple interfaces. For example, any software application located on a researcher's interface 30 might be shared with a panelist's interface 25, or a consumer might collect habits or diary data and share that data with a researcher via the application sharing software. As a result, it should be recognized that application sharing software 43 might be the only software required on a panelist interface 25 to allow a consumer panelist 26 to interact with (such as manipulate, modify and select) any image associated with an online data collection system 15.

It should be recognized that because a panelist interface 25 and a research interface 30 can be located anywhere in the world, online data collection, such as online interviewing, could be conducted at any time and from any location. In other words, there might be no temporal or geographic boundaries to the present invention and its applications. In a further embodiment, application sharing software 43 might allow a researcher 31 and/or panelist 26 to print instant transcripts of an interview. The transcripts may help a researcher 31 to formulate additional questions based on information already covered, or assist a panelist in undertaking follow-up exercises. It is also contemplated that a system 15 might be provided with additional “artificial” intelligence that in the form of instructions, programs or other logic that might allow a system 15 to generate additional questions based on the data collected. Finally, the transcripts of an interview may be automatically created based on voice recognition or some other form of technology.

It should also be recognized that as technology advances, executable instructions, such as in the form of application sharing software 43 may allow a researcher 31 to provide a plurality of other sensory stimulating elements such as smells, scents or flavors associated with a product, such as a laundry detergent or a new type of soda. In this scenario, consumers 26 might be provided with additional hardware or software that allows the images 21 of the image bank module 20 to be configured to provide a specific sound, smell, scent or flavor, such as for example, the smell of an ocean may be emitted when an image of an ocean is displayed. It might also be possible to provide other stimulus such as tactile simulation through a “glove” for allowing a consumer 26 to pick-up or feel the weight of a product or to feel the texture of a product.

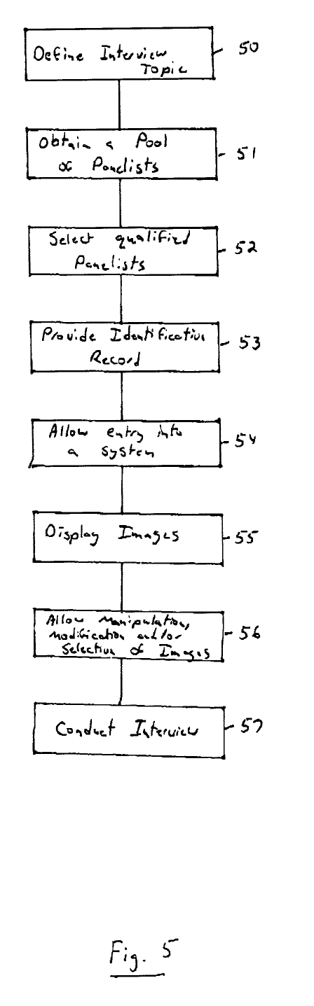

FIG. 4. depicts another exemplary embodiment of the present invention wherein it is contemplated that an online data collection system 15 may further be provided with an audio connection 34. Such an audio connection 34 might be provided between a panelist interface 25 and a research interface 30 in combination with a web cam 36. In this embodiment, software provided to operate a video connection 35 may also coordinate an audio connection 34. In an alternate embodiment, a researcher 31 and a panelist 26 might communicate via a telephone, wireless telephone, or any other communication device.

It should be recognized that providing an audio connection 34 between a panelist interface 25 and a research interface 30 should allow a panelist and a researcher to share and record sounds. A researcher 31 might be provided with further insight by studying background noises and/or tone of voice of a panelist, and/or it may also be possible to quantify a panelist's stress level, mood or emotions, based on the sounds generated from an audio connection 34.

FIG. 4 further depicts a research module 45 in communication with an image bank module 20 and a research interface 30. Once again, as with all the components of the system 15, it should be recognized that the functions associated with a research module 30 might be provided on any component of a system 15. A research module 18 might be configured to record every keystroke, mouse click or other panelist input while a panelist 26 is viewing, responding, contemplating, reacting, manipulating, modifying, adding, selecting or submitting images. In this way, not only might a researcher 31 know which selections a consumer panelist ended up making, but also how a consumer panelist arrived at a final submission. As a result, a research module 18 might provide a researcher 31 with additional data relating to a consumer's behaviors and decisions relating to consumer product research and development.

It should also be recognized that data collected by a system 15 does not have to be limited to “clicks” of a mouse or keystrokes, and the like. It is contemplated that a panelist might be provided with blood pressure or heart monitoring devices, brain activity monitor, an eye tracking device, or any other type of device that might provide a researcher 31 with additional detail relating to an interview.

FIG. 4 further contemplates that a data collection system 15 may be provided with a data store 40, which could comprise multiple data stores in multiple locations, and can be provided with backup data stores to ensure the system 15 is operable at any time and from any location. It should also be recognized that a data store 40 could be in selective communication with any component of a system 15.

In a non-limiting embodiment of the invention, a data store 40 might be provided with data comprising at least one image 21 and might also store any information provided by a consumer 26 such as background information such as income level, products typically purchased and geographic information, or any other inputted information such as image selections, submissions, manipulations, additions, and modifications In an exemplary embodiment, a data store 40 might be provided with between about 1000 and 1500 non-duplicative images, or as many or as few as desired, such that the researcher 31 might be capable of downloading an image 21 into an image bank module 20 for display at a panelist interface 25.

It is further contemplated that an online data collection system 15 might be configured to allow for system supervision, maintenance, upgrades and general monitoring of the system 15 by a system administrator. In a non-limiting embodiment of the invention, it is contemplated that a researcher 31 might assume the responsibilities of a system administrator, and a system administrator could be located on site with a system server in some applications, or might have the ability to access the components of a system 15 from remote locations. More importantly, it is contemplated that a system administrator have ready access to any component of the system 15 at any time for maintenance, monitoring, security, upkeep and updating.

FIG. 5 depicts an exemplary embodiment of a method of using an online interviewing system 15, such as that relating to identifying factors that may underlie consumer purchase decisions. As will be more fully discussed in detail, a researcher might first define an interview topic (block 50), obtain a pool of panelists (block 51) willing to participate in an online interview, and select one or more qualified panelists (shown at 52) from the pool of panelists. Each selected qualified panelist might be provided with an identification record (e.g., block 53) that allows entry (e.g., at 54) into a system. Upon entering a system and reviewing an appropriate welcome screen, a system might display a plurality of images (as indicated at 55) and be configured to allow manipulation, modification and/or selection of any displayed image (e.g., 56). Finally, after a consumer panelist selects and submits a predetermined number of images, an interview might be conducted (e.g. at 57) by a researcher to collect data and understand the psychological aspects of the images selected by a consumer panelist.

In particular, it is contemplated, that a researcher might first define a particular interview topic (e.g. at 50), such as, for example, determining the role of Febreze® fabric deodorizer in a consumer's life to better understand ways in which consumers use or might use such a product. Another example of a particular interview topic may be determining ways to improve the diapering process of a child. It should be recognized that these are only two examples of a virtually unlimited variety of topics definable by a researcher.

After a researcher has defined an interview topic, a pool of panelists willing to participate in online data collection relating to the interview topic might be obtained, as shown at block 51. In this exemplary embodiment, a pool of consumer panelists might be obtained through a research supplier such as National Family Opinion (NFO) or through an in-house internal panelist list. In another embodiment, a pool of consumer panelists might be obtained through advertising on an Internet portal such as America Online, Yahoo, or other highly visible web-site. In either case, potential consumer panelists who volunteer to participate in an online interview may be required to complete a survey comprising a plurality of introductory questions relating to products they currently use, where they live, income range and general family information. A survey might be capable of being completed on-line, or might be submitted through traditional approaches.

A researcher might then select a limited number of qualified panelists (block 52) from the pool of panelists to participate in an online data collection project. For example, based on a researcher's defined interview topic, a researcher may screen surveys completed by potential panelists within the pool of panelists. In more detail, if a manufacturer would like to improve a baby diapering process, a researcher may, at a minimum, require potential consumer panelists to have children of diaper wearing age in the household. Other examples may include, but are not limited to screening-out male candidates for analysis of feminine hygiene products or screening non-soda drinkers to test the market acceptance of a new or improved brand of soda. In addition, a researcher may also screen survey's based on the occupation of the potential panelist, the potential panelist's employer, or any other type of information.

Upon determining a qualified selection of consumer panelists (block 52), it is contemplated that the panelists might be contacted through e-mail or any other method of communication. In an exemplary embodiment of the invention, a researcher may provide each qualified consumer panelist with an identification record such as a username and password that might allow the panelist to access a system 15. In an alternative embodiment, an identification record (block 53) could be embedded in a URL transmitted to a qualified consumer panelist. It is contemplated that by providing a panelist an identification record, a panelist could access a system 15 at any time that is convenient for the panelist, and might allow a consumer panelist to access a system as many times as desired until a panelist completes a researcher's desired objective. In fact, the number of times of access by a panelist may itself be valuable data.

A panelist might then be allowed to access or enter a system (e.g., block 54) through a panelist interface having an Internet connection. For example, upon accessing an appropriate web-page, a consumer panelist might be asked to “log on” to a system 15, wherein at an appropriate “log on” screen, a panelist may input required identification, such as a user name and password provided with an identification record, which a panelist interface (e.g., 25) might compare against information stored in a system data store (e.g., 40). If a match is found, the system might allow a panelist to access or enter a system and might display an introductory screen having a message such as:

“Thank you for agreeing to participate in an interview with us. While at image bank, you be able to browse through a set of randomly selected images and choose images which you will talk about during your interview. Please choose 8 to 12 images for your interview that represent those thoughts and feelings that come to mind when you think about your interview topic. After selecting your 8 to 12 images, you will have the option of placing the images in any order you would like. There is no right or wrong way to order the images. However, your interview will follow the order of the images that you decide upon.”

It should be recognized that an introductory screen may comprise any type of welcome information and text as desired, and should generally state the nature of the interview process. For example, a researcher 31 may choose to display the images in a predetermined order rather than a random order, or may have a consumer panelist choose more or less than 8 to 12 pictures. A consumer panelist 26 might be asked to select and submit between about 1 and about 50 images from the image bank, such as between about 5 and about 20 images, or between about 8 and about 12 images.

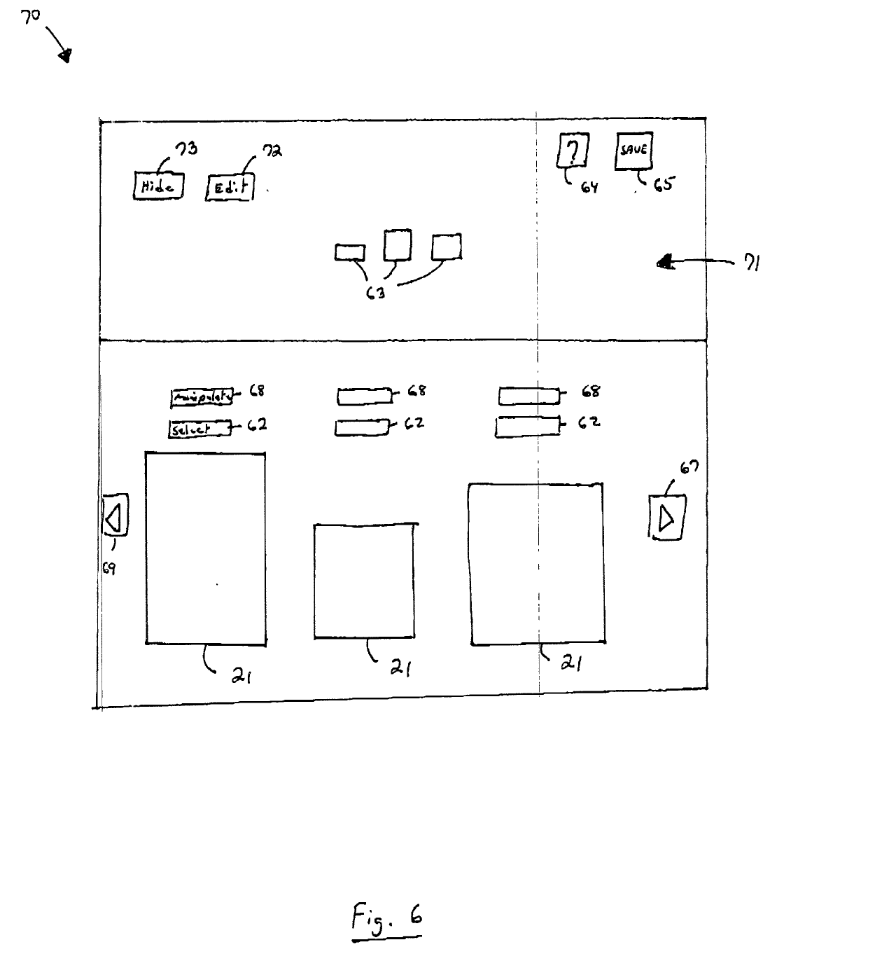

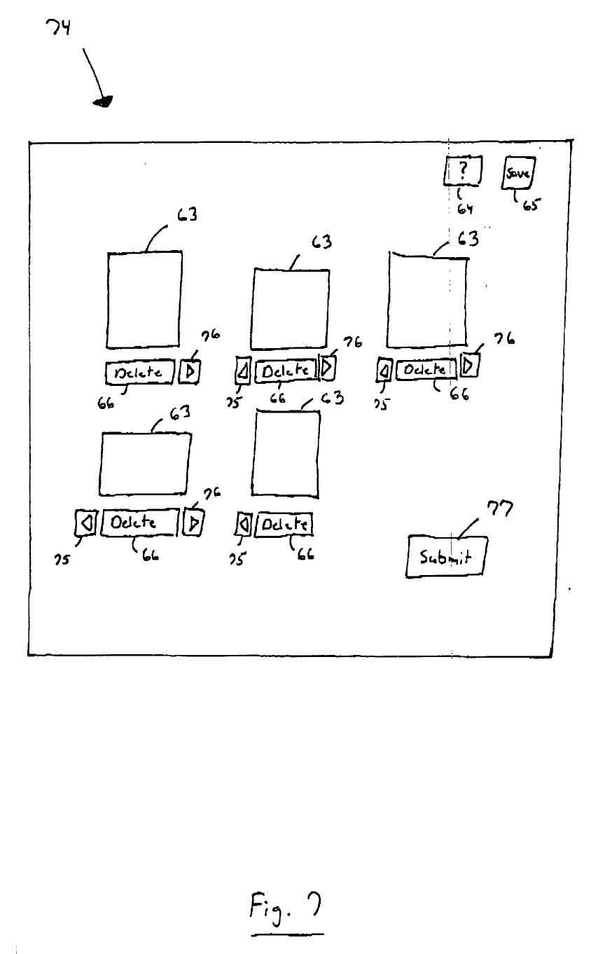

After a consumer panelist carefully reviews an introductory screen and chooses an appropriate continuation icon, a system electronically transmits a visual display of a plurality of images (block 55). In particular, as illustrated in FIG. 6, an image bank module 20 displays a Selection page 70 having a group of three, side-by-side images 21, all of which are configured to be selected or manipulated by a consumer panelist 26 via a panelist interface 25. In one embodiment of the invention, the images 21 from the image bank module 20 might be provided randomly at a panelist interface 25. In other words, a system 15 is provided with instructions, such as a random image generator 80, as illustrated in FIG. 4, to enable a random display of a plurality of images 21 at a panelist interface 25. Any random number generator 80 known in the art should allow one skilled in the art to implement a random display of images 21 from an image bank(e.g. 20). In an alternate embodiment, a researcher 31 may choose as many or as few pictures as desired to be displayed at a panelist interface 25, and a researcher might also be able to designate the particular order and presentation (e.g., all simultaneously show, one shown at a time, time of display, etc.) in which the images 21 are displayed at a panelist interface 25. As a result, it should be recognized that a system 15 comprises instructions to enable a researcher to display a plurality of images 21 at a panelist interface 25 in any predetermined manner and that a researcher 31 has the capability to chose the number, order and presentation of images 21 to be displayed at a panelist interface 25.

It should be understood that the term “instructions” includes the ability of the system to carry out presentation or display of the images. For example, instructions could be in the data signal or they could be configured in the images that get transmitted, such that once the images reach the panelist interface, the images present themselves in a predetermined manner to the user.

A consumer panelist 26 might be then allowed to manipulate, modify and/or select 56 any image 21 representative of a panelist's thoughts and feeling about a particular interview topic. In FIG. 6, it is contemplated that a consumer panelist 26 might have the opportunity to manipulate any image 21, for example, via a “Manipulate” icon 68, such as by adding or changing text, symbols, graphics or subtopics. A consumer panelist 26 might also be allowed to continue to another display of images 21, such as via a “Continue” icon 67, to find the images 21 that best relate to the interview topic or might be able to review previously displayed images by choosing a Previous Page icon 69.

Finally, as FIG. 5 illustrates, a final step in a method might be that once a consumer panelist 26, selects the desired number of images he or she might submit those images to the image bank module to invoke the interview process 57. The term “submit” is contemplated to include the meaning that the images selected by a consumer panelist that best represent the panelist's thoughts and feeling relating to a particular interview top which are transmitted to a system 15 for the purpose of facilitating an interview with a researcher. While it is contemplated that a consumer panelist 26 might be allowed to enter or exit a system 15 numerous times and view, add, manipulate, modify, select and save any image during any visit to the system, he or she submits the selected images to the system 15, the consumer panelist might not be allowed to manipulate, modify or otherwise change those selections.

It is contemplated that once a consumer panelist 26 submits the desired selected images to a system, in particular, an image bank module 20, the image bank module 20 might transmit a message such as an e-mail or alert to a researcher to communicate that the consumer has submitted the selected images and is now ready for the data collection or interview to begin. In the alternative, a consumer panelist 26 may be given a limited period of time to complete the selection and submission process, and an interview date may be scheduled. In this case, a researcher 31 might call a consumer panelist on a prescheduled date to conduct an interview.

Upon receiving confirmation of consumer panelist's submissions or at a prescheduled date, a researcher 31 might communicate with a consumer panelist 26 to further discuss the images selected and submitted by the consumer panelist 26. A researcher 31 might then utilize a number of research techniques to conduct an interview with a consumer panelist, including, but not limited to Kelly Repertoire Grid, Storytelling, Deeper Insights, Priming, Concepts Research and the like. By way of example, in Storytelling, a researcher 31 might have a consumer panelist 26 tell a story about the pre-assigned interview topic using each of the selected images. In Kelly Repertoire Grid research, a researcher 31 might ask a consumer panelist to tell why they selected a particular image or group of images and might also utilize a research interface 30 to share additional or manipulated images with the panelist. Other test techniques might contemplate a researcher 31 selecting and sharing images as stimulus for tasks and/or for further discussion. It should be recognized that a researcher is not limited to using any of these techniques, but rather, system 15 is designed to allow a researcher to use any of these techniques standalone or in conjunction with any other interview technique as appropriate to elicit panelist response. It is believed to that consumer interaction with the images will elicit sensory aspects related to the topic being studied. As a result a researcher may be able to collect data relating to the underlying reasons the consumers selected a particular product. In this way, a researcher 31 might be able to obtain data to create a better product.

FIG. 6 shows an exemplary embodiment of a selection page 70 as displayed at a panelist interface 25. In this embodiment, it is contemplated that images 21 might be displayed in groups (e.g., three) of side-by-side or successively presented images, wherein a consumer panelist 26 might have the opportunity to select an image 21 representative of his/her thoughts and feelings about the image as it relates to an interview topic 50 via a “Select” icon 62. Additionally, as shown in FIG. 6, a consumer panelist's 26 selections might also be shown on the selection page 70. The selected images 63 might be displayed in an area of the Selection page termed Selection Group Area 71. A Selection Group Area 71 might allow a consumer panelist 26, through executable instructions, to hide the Selections Group Area 71, via a Hide icon 73, or edit the Selection Group Area 71 via an Edit icon 72. It should be understood that the selected images 63 in a Selection Group Area 71 might represent the thoughts and feelings of the panelist as related to the interview topic. Moreover, it should be recognized that a Selection Page 70 might be configured with any number of icons that allow selection or de-selection of a particular image or allow editing, modification or manipulation of a particular image. For example, a Selection Page 70 might comprise icons that allow on a consumer panelist to save selections, via a Save icon 65 or receive help through a Help icon 64. Panelists might also be allowed to caption or annotate the images they selected.

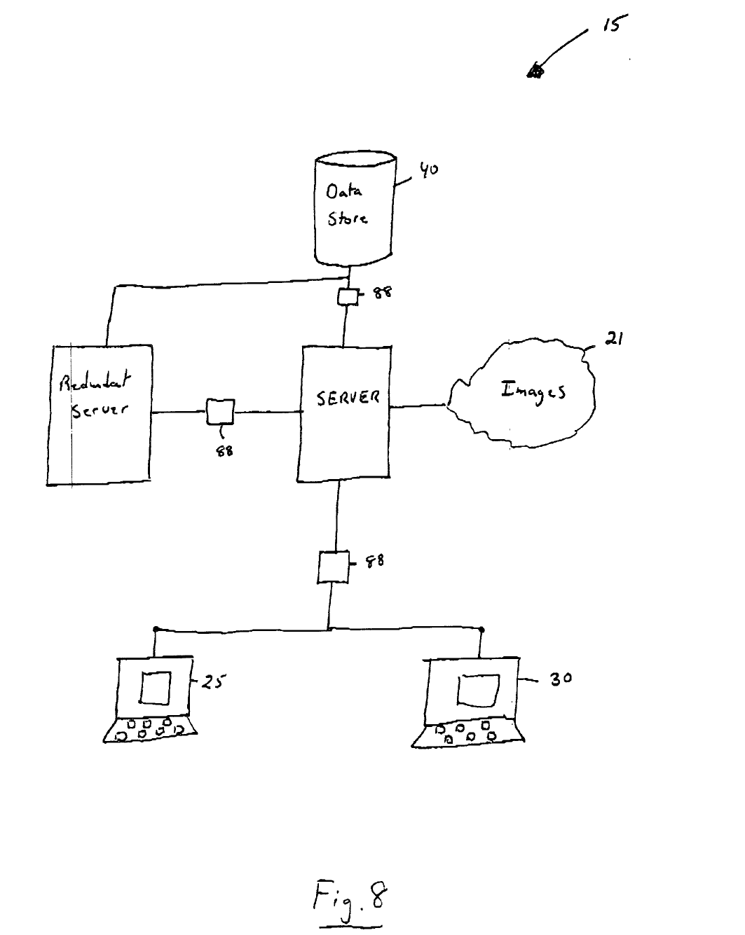

FIG. 7 illustrates an exemplary embodiment of an Edit Selections Group page 74 that might be displayed upon selection of an Edit icon 72. In this example, a system 15 might transmit an Edit Selections Group page 74 for editing by a consumer panelist 26. Each image 63 selected might be displayed in the Edit Selection Group page, and the panelist might be able to de-select any particular image at anytime such as through a Delete icon 66. Moreover, it should be recognized that selected images 63 displayed on an Edit Selections Group page 74 might be configured to be modified, or ordered in any desired manner, by consumer panelist 26. Although it should be recognized, that many alternate methods of allowing a panelist to order or manipulate a group of images could be configured, in an exemplary embodiment, a consumer panelist 26 might “click” on a Left Arrow icon 75 to move a picture to the left or a Right Arrow icon 76 to move an image to the right. In an alternate embodiment, it is also contemplated that a consumer panelist 26 might also be able to “click” and “drag” an image to any desired location. Further, an Edit Selections Group page 74 might also comprise an icon such as a “Submit” icon 77 which might transmit the image selections 63 and desired order of those selections to an image bank module 20 to facilitate the interview process. In an exemplary embodiment, a Submit icon might not be displayed until a consumer panelist selects a minimum number of pictures as desired by a researcher. Once again, an Edit Selections Group page 74 might also comprise a plurality of other icons related to the page such as a Continue icon 67, a Save icon 65 or a Help icon 64. As understood, specific pages or screens of any panelist interface or system of the present invention can be likely varied to accommodate research project parameters and/or panelist preferences.

Having shown and described the preferred embodiments of the present invention, further adaptations of the on-line data collection system of the present invention as described herein can be accomplished by appropriate modifications by one of ordinary skill in the art without departing from the scope of the present invention. Several of these potential modifications and alternatives have been mentioned, and others will be apparent to those skilled in the art. For example, while exemplary embodiments of the system have been discussed for illustrative purposes, it should be understood that the elements described will be constantly updated and improved by technological advances. Accordingly, the scope of the present invention should be considered in terms of the following claims and is understood not to be limited to the details of structure, operation or process steps as shown and described in the specification and drawings.

What is claimed is:

1. An online system for collecting data from one or more panelist comprising:
an image bank module for communication with a plurality of images;
executable instructions in communication with said image bank module and configured to facilitate access to and display of said images to one or more panelist;
a research interface arranged in communication with said image bank module, said research interface configured to allow access to panelist input comprising a selection of at least one image from said display of said plurality of images; and
a communication device provided at said research interface configured to facilitate analysis of said panelist input.

2. The online system for collecting data of claim 1, wherein said executable instructions are configured to provide selective manipulation of one or more of said images in said image bank module.

3. The online system for collecting data of claim 1, wherein said executable instructions comprise application sharing software.

4. The online system for collecting data of claim 1, wherein said executable instructions are configured to allow additional images to be added to said image bank module.

5. The online system for collecting data of claim 1, wherein said communication device comprises a web cam for receiving and displaying video.

6. The online system for collecting data of claim 1, wherein said executable instructions enable a random display of a plurality of images at said panelist interface.

7. The online system for collecting data of claim 1, wherein said system comprises instructions to enable selection of a plurality of images for display to a panelist in a predetermined order.

8. The online system for collecting data of claim 1, further comprising a panelist interface in communication with said executable instructions.

9. The online system for collecting data of claim 8, wherein said research interface is located remotely from said panelist interface.

10. The online system for collecting data of claim 1, wherein said system is configured to facilitate selection of between about 1 and about 50 images from said plurality of images.

11. A method of collecting data from one or more panelist comprising the steps of:
providing an image bank module for communication with a plurality of images, said image bank module in communication with executable instructions configured to provide access to and display of said plurality of images and to facilitate a panelist input comprising a selection or manipulation of at least one image from said display of said plurality of images;
providing a research interface arranged in communication with said image bank module and in communication with said executable instructions; and
providing access at said research interface to said panelist input.

12. The method of collecting data of claim 11, further comprising the step of randomly displaying said plurality of images at a panelist interface.

13. The method of collecting data of claim 11, further comprising the step of providing a communication device at said research interface to facilitate analysis of said panelist input.

14. The method of collecting data claim 11, further comprising the step of manipulating any one of said images in said image bank module.

15. The method of collecting data of claim 11, wherein said communication device comprises a web cam.

16. The method of collecting data of claim 11, wherein said executable instructions comprise application sharing software to facilitate image sharing.

17. A method of collecting data from one or more panelist comprising the step of receiving panelist input from a research interface, wherein said panelist input has been generated according to the method of claim 11.

18. A method of collecting data from one or more panelist comprising the step of receiving panelist input from a research interface, wherein said panelist input has been generated according to the method of claim 13, said panelist input including selection of at least one images and information from said communication device.

19. The method of collecting data of claim 11, wherein said data collected comprises at least one of the following: interview questions and answers, audio observations, visual observations, body language, emotions, image selections, additions, modifications and manipulations.

20. A computer readable medium containing instructions for controlling a computer system for providing online data collection, by:
providing an image bank module for communication with a plurality of images;
providing executable instructions in communication with said image bank module and configured to facilitate access to and display of said images to one or more panelist;
providing a research interface arranged in communication with said image bank module, said research interface configured to allow access to panelist input comprising a selection or manipulation of at least one image from said display of said plurality of images; and
providing access at said research interface to said panelist input.

21. The computer readable medium of claim 20, further comprising the instruction of allowing additional images to be added to said image bank module.

22. The computer readable medium of claim 20, further comprising the instruction of randomly displaying said plurality of images at a panelist interface.

23. The computer readable medium of claim 20, further comprising the instruction of allowing selective manipulation of one or more of said images in said image bank module.

24. The computer readable medium of claim 20, wherein said data collection comprises at least one of the following: interview questions and answers, audio observations, visual observations, body language, emotions, image selections, additions, modifications and manipulations.
